(19) United States
(12) Patent Application Publication
(10) Pub. No.: US 2015/0163624 A1
(43) Pub. Date: Jun. 11, 2015

(54) DETERMINING MOBILE DEVICE LOCATION IN A MOBILE NETWORK HAVING REPEATERS

(71) Applicant: Tektronix, Inc., Beaverton, OR (US)

(72) Inventors: Ralf Kreher, Berlin (DE); Julien Schnerrer, Berlin (DE); Martin Polak, Berlin (DE); Martin Winau, Berlin (DE)

(73) Assignee: TEKTRONIX, INC., Beaverton, OR (US)

(21) Appl. No.: 14/101,831

(22) Filed: Dec. 10, 2013

(51) Int. Cl. H04W 4/02

(52) U.S. Cl. CPC H04W 4/02; H04B 7/14

(57) ABSTRACT

A method for determining mobile device location in a wireless communication network having plural base stations and at least one repeater for communicating with a mobile device is performed by a geolocation detection program for locating a mobile device. The geolocation detection program determines whether a signal received from the mobile device has passed through the at least one repeater.

### FIELD OF THE INVENTION

The invention generally relates to mobile communications networks, and more particularly, to determining a mobile device being located in a mobile communications network having repeaters.

### BACKGROUND OF THE INVENTION

The use of mobile communication devices such as telephones, pagers, personal digital assistants, laptop computers, etc., hereinafter referred to collectively as User Equipment (UE), has become prevalent in today's society. Repeaters, distributed antenna systems, and similar signal repeating systems are wireless communication systems that are used to extend coverage into areas where the radio frequency (RF) signal penetration from base transceiver stations is limited or not present. Those low signal or no signal areas might be inside buildings, in tunnels, shadowed areas that are behind mountains, underground train systems, and various other isolated areas. Generally, applications for such repeater communication systems are for situations where the repeater is immobile and is mounted in a fixed location with respect to one or more base transceiver stations.

### SUMMARY OF THE INVENTION

The purpose and advantages of the invention will be set forth in and apparent from the description that follows. Additional advantages of the invention will be realized and attained by the devices, systems and methods particularly pointed out in the written description and claims hereof, as well as from the appended drawings.

To achieve these and other advantages and in accordance with the purpose of the invention, as embodied, the invention includes, in one aspect, a computer implemented method and system for determining mobile device location in a wireless communication network having plural base stations and at least one repeater for communicating with a mobile device. The wireless communication network uses a geolocation detection program for locating a mobile device. The geolocation detection program determines whether a signal received from the mobile device has passed through the at least one repeater.

### BRIEF DESCRIPTION OF THE DRAWINGS

The accompanying appendices and/or drawings illustrate various non-limiting, example, inventive aspects in accordance with the present disclosure:

FIG. 1 illustrates an exemplary wireless communication system in which illustrated embodiments of the present invention may be implemented:

FIG. 2 shows a simplified block diagram of a repeater used in the wireless communication system of FIG. 1 in accordance with an illustrated embodiment;

FIG. 3 is an illustration of a wireless communication system with repeater stations connected with an RF link and over a tether in accordance with an illustrated embodiment;

FIG. 4 is a flowchart of operational steps of a geolocation application used in the wireless communication system of FIG. 1 in accordance with illustrative embodiments of the present invention; and

FIG. 5 illustrates internal and external components of a geolocation server computer of FIG. 1 in accordance with an illustrative embodiment of the present invention.

### DETAILED DESCRIPTION OF CERTAIN EMBODIMENTS

The present invention is now described more fully with reference to the accompanying drawings, in which an illustrated embodiment of the present invention is shown. The present invention is not limited in any way to the illustrated embodiment as the illustrated embodiment described below is merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the present invention. Furthermore, the terms and phrases used herein are not intended to be limiting but rather to provide an understandable description of the invention.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the embodiments of this invention as discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

The term “geolocation”, as used herein, refers to a geographic location of a mobile device as well as geographic location of a communication event observed by user equipment. The term “communication event”, as used herein, refers to any incoming or outgoing communication to or from a mobile device. Communication events include mobile station attachment, detachment, handover procedures, telephone calls, both sent and received, SMS messages both sent and received, e-mail correspondences both sent and received, and wireless application protocol sessions, among other data based transactions. Each communication event has at least two parties, the user of the mobile device and at least one correspondent element. The terms “mobile device” and “mobile station” may be used interchangeably herein.

In addition, the term “repeater” refers to a system or device that receives, amplifies, and retransmits a wireless signal without extracting the user information or converting the communication protocol.

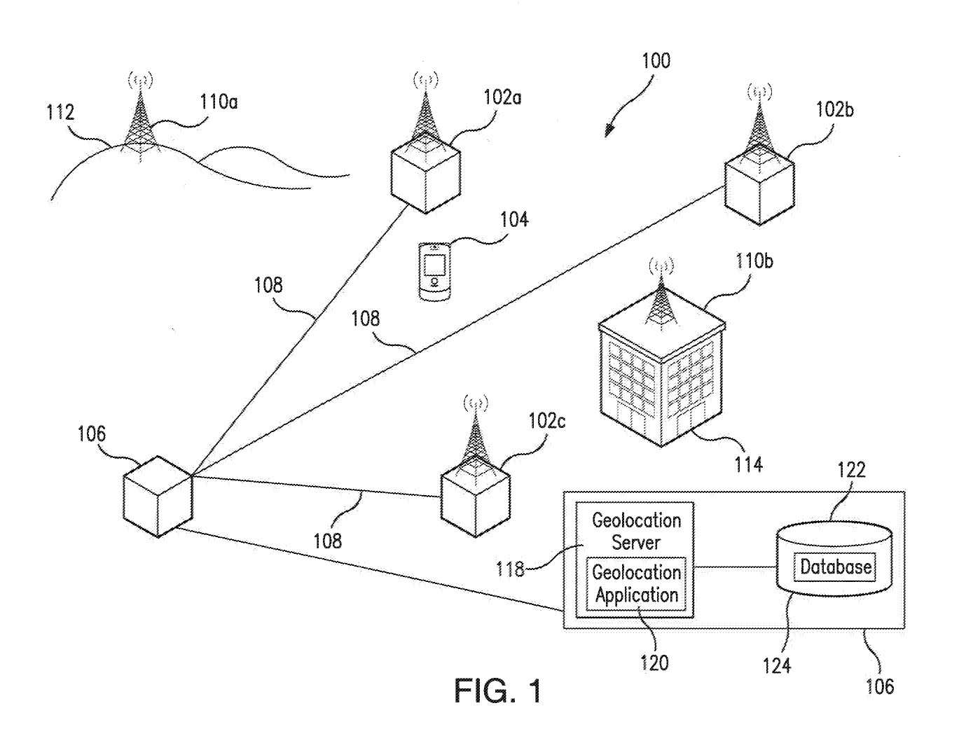

Turning now descriptively to the drawings, in which similar reference characters denote similar elements throughout the several views, FIG. 1 depicts an exemplary wireless communication system in which illustrated embodiments of the present invention may be implemented.

FIG. 1 shows a conventional wireless communication system 100 having base stations 102a-c for communicating with a mobile device 104. Each base station 102a-c contains signal processing equipment and an antenna for transmitting to and receiving signals from the mobile device 104 as well as other base stations 102a-c.

To meet the ever growing demand for mobile communication, wireless communication systems, such as communication system 100 shown in FIG. 1, deploy repeater stations to expand range and concentration of coverage. In FIG. 1, a repeater 110a, associated with base station 102a, is located to extend the coverage area to encompass the back side of the mountain 112. The repeater 110b, associated with base station 102c, is mounted on a building and is used to provide service within the building 114. Repeaters 110a,b are often deployed in areas with good outdoor coverage in order to ensure sufficient indoor coverage of important buildings or structures, such as, for example, but not limited to airports, hotels, schools, subway tunnels, and the like. In this architecture, the base station 102a-c typically have no knowledge that a call is being served by the repeater 110a,b.

A Mobile Switching Center (“MSC”) 106 typically is connected to each base station 102a-c through wireline connection 108. The MSC 106 may include a geolocation server 118. In the normal course of operation, the geolocation server 118 is tasked to generate a location estimate on a particular mobile device. The tasking is accomplished by collecting information on the mobile device of interest from the plurality of base stations 102a-c. The geolocation server 118 then employs the received information to compute a location estimate by running a geolocation application 120, as described below.

The base stations 102a-c may be configured to make measurements and collect a variety of data. The data collected by the base stations 102a-c may include, for each signal detected, the signal source's identification information, such as a IMSI

(International mobile Subscriber Identity), MSISDN, MAC (Media Access Control) or EUI (Extended Unique Identifier) identifier or the signal's frequency; the signal's average signal strength; the standard deviation of its signal strength; and its yield, which is a measure of how often the signal is detected over a given time period. When monitoring, the base station 102a-c may collect a plurality of samples, or “polls”, of the detectable signals.

In addition to collecting signal-related information, the base station 102a-c may collect a plurality of control parameters. For example, when the mobile device 104 initiates or receives a call or text message, radio communication takes place between the device and a base station, for example, base station 102a. In addition to transmitting an encoding of the message passing between caller and call recipient, the mobile device 104 and the base station 102a transmit a large amount of control information between themselves for the purposes of reliably and efficiently supporting the call and passing it between base stations 102a-c as the user operating mobile device 104 moves about. This control information may contain information on the signal strength of neighboring base stations, network's propagation path time measurements (e.g., timing advance information, propagation delay), transmission error rates and much more. Collectively these parameters are referred to herein as the “control parameters”. From this information, the geolocation server 118 determines accurate information related to the geolocation of the mobile device 104 and the geolocation of the corresponding communication events, as described below. At least in some embodiments of the present invention, the geolocation server 118 may send the geolocation information of interest back to the mobile device 104. The mobile device 104 may display the received geolocation information (e.g., an indicator that a signal passed through a repeater, discussed below) to a user utilizing, for example, a graphical user interface (GUI) (not shown in FIG. 1).

It is noted that the mobile device 104 is depicted in FIG. 1 as a mobile wireless device such as a cell phone or smart phone. However, it may be any portable device, such as a laptop, notebook, tablet computer, palm-sized computer, or any electronic device with capability to receive communication (i.e. wireless) signals.

Geolocation application 120 may comprise program instructions stored on one or more computer-readable storage devices, which may include internal storage on the geolocation server 118. Geolocation application 120 may be, for example, a computer program or program component for determining accurate geolocation information. Data gathered, generated, and maintained for use by the geolocation application 120 may be kept in the internal storage of the geolocation server 118 or in one or more databases 124 of a storage unit 122 contained within the MSC 106.

The wireless communication system 100 shown in FIG. 1 may comprise a radio access network (RAN). For purposes of the present patent application, the RAN may be implemented in any combination of known or heretofore unknown radio access technology and network protocols. For instance, the RAN may comprise a combination of UMTS Terrestrial Radio Access Network (UTRAN), Wireless Local Area Network (WLAN), Digital Enhanced Cordless Technology (DECT), GSM EDGE Radio Access Network (GERAN), Worldwide Interoperability for Microwave Access (WiMAX) network, Device to Device (D-D), etc. The RAN can also be an aggregation of channels from multiple bands in the radio access technology LTE-A (Long Term Evolution-Advanced). LTE-A is a set of enhancements to the Universal Mobile Telecommunication System (UMTS) that includes an all-IP networking architecture and the ability of each base station to connect to multiple core networks.

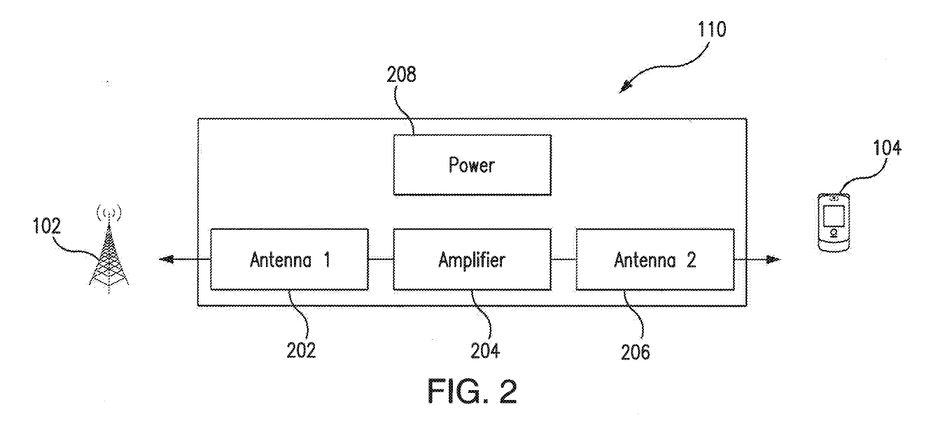

FIG. 2 shows a simplified block diagram of a repeater used in the wireless communication system of FIG. 1 in accordance with an illustrated embodiment. The repeater arrangement 110, in accordance with an embodiment of the present invention comprises a first antenna 202, for example, an outdoor antenna in a fixed position which preferably transmits outdoor communication signals. In other words, the first antenna 202 transmits and receives communication signals to/from a plurality of base stations 102a-c shown in FIG. 1.

The repeater arrangement 110 also comprises a second antenna 206, for example, an indoor rebroadcast antenna. This second antenna 206 transmits and receives communication signals to/from the mobile devices located indoors.

The repeater arrangement 110 further comprises an amplifier device 204 operatively connected to the first 202 and second 206 antennas. A communication signal received at one antenna is input to the amplifier device 204, which amplifies and conveys the communication signal and outputs it to the other antenna. It is noted that the repeater arrangement 110 is a one-way repeater; that is, for any given moment in time one antenna is used for reception and the other for transmission.

In accordance with an embodiment of the present invention, the signal path in uplink and the signal path in downlink within the repeater arrangement 110 are symmetrical. The signal path is the path within the repeater arrangement 110, from the first antenna 202 to the second antenna 206. The first signal path, comprising, for example, a conductor, provides within the repeater arrangement 110 a signal path from the second antenna 206 to the first antenna 202, i.e. provides the uplink. The second signal path is correspondingly a signal path from the first antenna 202 to the second antenna 206, i.e. provides the downlink. It is noted that the uplink and downlink signal paths have the same electrical length, and designed to provide a path for the communication signal such that they have the same influence on the phase and amplitude for uplink and downlink. The signal paths preferably provide the same identical amplitude and phase characteristics to a signal. For example, a possible phase change should be preferably the same for both uplink and downlink. In addition, the signal paths could be designed to preserve an absolute phase of the communication signal. The absolute phase of, for example, the uplink may be any arbitrary phase, as long as the reverse link, in this example the downlink, has the same absolute phase. The first and second signal paths preferably also have the same attenuation. True reciprocity is thereby obtained in the repeater arrangement 110. The signal paths are preferably designed to provide identical phase and amplitude characteristics as function of frequency for both uplink and downlink. In other words, the signal paths are designed to give the same effects on the communication signal in both uplink and downlink.

In an embodiment of the present invention, the repeater arrangement 110 further comprises a power supply 208. The power supply 208 may be any of numerous types of stand-alone electrical power sources. For example, the power supply 208 may include one or more batteries and appropriate signal conditioning circuitry or it may be a thermoelectric power source, or it may be a vibration-powered generator that converts mechanical power to electrical power. In a particular example, the power supply 208 is implemented as a battery. A more typical commercial repeater 110 may have additional components including additional filtering and control elements to control noise, out of band emissions, and to regulate the gain.

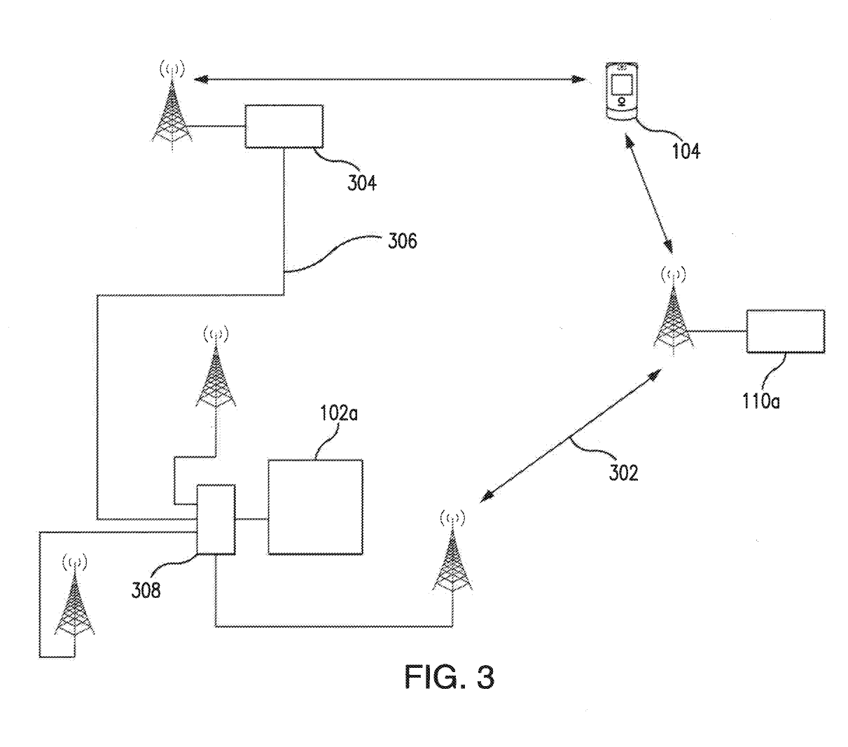

FIG. 3 is an illustration of a wireless communication system with repeater stations connected with an RF link and over a tether in accordance with an illustrated embodiment. Repeaters typically communicate with the host base station via an RF link 302, as shown in FIG. 3, between base station 102a and repeater 110a. This connection allows remote operation of the repeater without physical ties back to the host base station, which is particularly advantageous in rugged or other areas where laying lines are difficult or costly. Some repeaters, however, may use a fiber optic or copper wire “tether” instead of the RF link 302 to communicate with the host base station as shown in FIG. 3, where base station 102a is connected to repeater station 304 by tether 306. RF signals are placed onto the tether 306 at the repeater, and then summed into the normal base station antenna path at the antenna feed interface 308 at the host base station 102a. After integration into the normal base station antenna path, the signal from the repeater is indistinguishable to the base station 102a regarding its origin (e.g., from the base station antennas or from a tether). In this tether architecture as well, the host base station 102a has no knowledge that a call is being served by the repeater 304.

In summary, repeaters 110a,b in wireless communication systems 100 are devices for improving the wireless radio signal areas having poor or no coverage, by utilizing a reception antenna, a signal amplifier, and an internal rebroadcast antenna. Repeaters 110a,b typically use an external antenna, for example, first antenna 202 shown in FIG. 2 to receive, for example, outdoor RF signals, which are then passed to the amplifier unit 204. The amplifier 204 amplifies the signals and retransmits it to mobile devices 104 using the second antenna 206, providing significantly improved signal strength. It is noted that repeaters 110a,b are invisible to the base stations 102a-c located within the wireless communication system 100 since there is no specific signaling indication that wireless communication involved repeaters 110a,b. The radio signal path, however, is affected by the repeaters 110a,b due to additional, substantially constant, processing delay.

Currently in the art, there are a number of different methodologies to geolocate a mobile device. One well-known method for locating a mobile device is triangulation. Providers of wireless communication services have installed mobile device location capabilities into their networks. In operation, these network overlay location systems take measurements on RF transmissions from mobile devices 104 at base station locations 102a-c surrounding the mobile device 104 and estimate the location of the mobile device 104 with respect to the base stations 102a-c. Because the geographic location of the base stations 102a-c is known, the determination of the location of the mobile device 102 with respect to the base stations 102a-c permits the geolocation of the mobile device to be determined. In a triangulation method signal power level or signal timing measurements between the mobile device 104 and three or more base stations 102a-c are used to triangulate. The signal power level or signal timing measurements are used to estimate the distance between each base station 102a-c and the mobile device 104. The distances are plotted to determine a point of intersection. The point of intersection is the approximate transmitter location. For calculations using only signal power measurements, utilization of repeaters 110a,b in wireless communication systems 100 typically introduces significant geolocation errors with respect to wireless communication that involved at least one repeater 110a,b. Since base stations 102a-c typically do not know that a repeater is involved in wireless communication, triangulation calculation results are typically skewed due to a significant processing delay added to the propagation path time introduced by repeaters.

Another network-based geolocation technique involves estimating the location of a mobile device using, at least in part, one or more pre-existing Network Measurement Reports (“NMRs”) which may include calibration data and control parameters for a number of locations within a geographic region. The calibration data for these locations is gathered and analyzed so that particular points (e.g., “grid points”) within the geographic region can be determined and associated with a particular set or sets of calibration data from, for example, one or more NMRs. Then, the received signal level measurements and control information reported by the mobile device to be geolocated may be compared with the data associated with various grid points to estimate the location of the mobile device. The aforementioned repeater processing delay may affect this geolocation technique as well, due to the reasons discussed above.

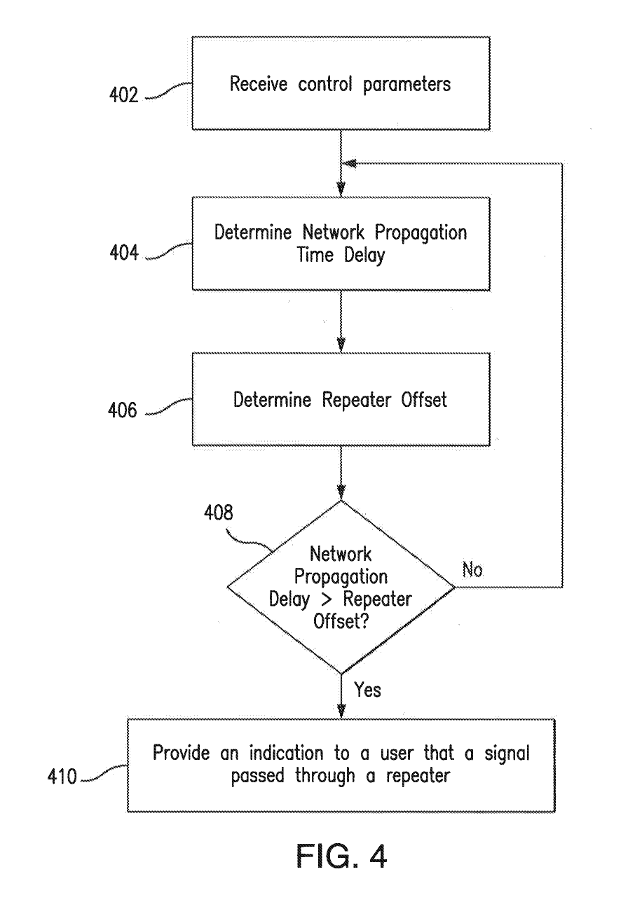

Advantageously, various embodiments of the present invention discussed herein provide a method of identifying wireless communication sessions that involve at least one repeater 110a,b. FIG. 4 is a flowchart of operational steps of a geolocation application used in the wireless communication system of FIG. 1 in accordance with illustrative embodiments of the present invention. The geolocation application 120 may be, for example, a computer program or program component configured to determine whether a wireless signal received from the mobile device has passed through at least one repeater.

At step 402, the geolocation application 120 preferably periodically receives control parameters from a plurality of the base stations 102a-c. As previously noted, these control parameters may contain information on the signal strength of neighboring base stations, network's propagation path time measurements (e.g., timing advance information, propagation delay), NMRs, transmission error rates and much more. In an embodiment of the present invention, the control parameters may be transmitted through wireline connections 108 between base stations 102a-c and MSC 106. In an embodiment of the present invention, this step preferably involves storing the received control parameters in the internal storage of the geolocation server 118 or in one or more databases 124 of a storage unit 122 contained within the MSC 106.

Next, at step 404, the geolocation application 120 preferably determines a communication network propagation time delay between a base station (e.g., base station 102a) and the mobile device 104. It is to be noted that this determination preferably involves the geolocation application 120 extracting the propagation time delay from the control parameters received at step 402. The propagation time delay is typically measured by the plurality of base stations 102a-c. This information may be exchanged between the base stations 102a-c within signaling protocol messages. All such details are well known in the art, and need not be explained further here.

At step 406, the geolocation application 120 preferably determines an offset of the propagation time delay associated with the at least one repeater. As previously indicated, the repeater 110a,b itself has some processing delay associated with it, primarily the result of filter components used within the repeater. Some repeaters may have a significant delay, particularly if they use saw filters for channelization. Other repeaters may not contain significant delay. To keep the analysis as general as possible, the repeater is assumed to have a constant value associated with the processing delay, which is higher than normal propagation time delay.

At step 408, the geolocation application 120 preferably compares the propagation time delay with the repeater offset determined at step 406. In response to determining that the propagation time delay value does not exceed the repeater offset (step 408, no branch), the geolocation application 120 preferably concludes that the analyzed wireless communication session did not involve a repeater. In an embodiment of the present invention, the geolocation application 120 may return back to steps 402 or 404, waiting for the next request to determine the presence of a repeater. In an alternative embodiment, the geolocation application 120 may next calculate geolocation of the mobile device based on the conventional network-based geolocation technique.

In response to determining that the propagation time delay value exceeds the offset associated with at least one repeater (step 408, yes branch), the geolocation application 120 preferably provides an indication to a user that the analyzed wireless signal passed through a repeater. As noted above, the geolocation application 120 may be configured to send the geolocation information of interest back to the mobile device 104. The mobile device 104 may display the received geolocation information (e.g., an indicator that a signal passed through a repeater) to a user utilizing, for example, GUI (not shown in FIG. 1). If the mobile device 104 requests its geographic position, the geolocation application 120 may estimate such position based on the known geographic position of the closest repeater, for example, repeater 110b.

In summary, method for determining mobile device location in a wireless communication network having at least one repeater described herein advantageously detects a presence of the repeater and takes the processing delay associated with the at least one repeater into account in calculating the mobile device location. Accordingly, the embodiments described herein provide improved methodologies to geolocate a mobile device.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

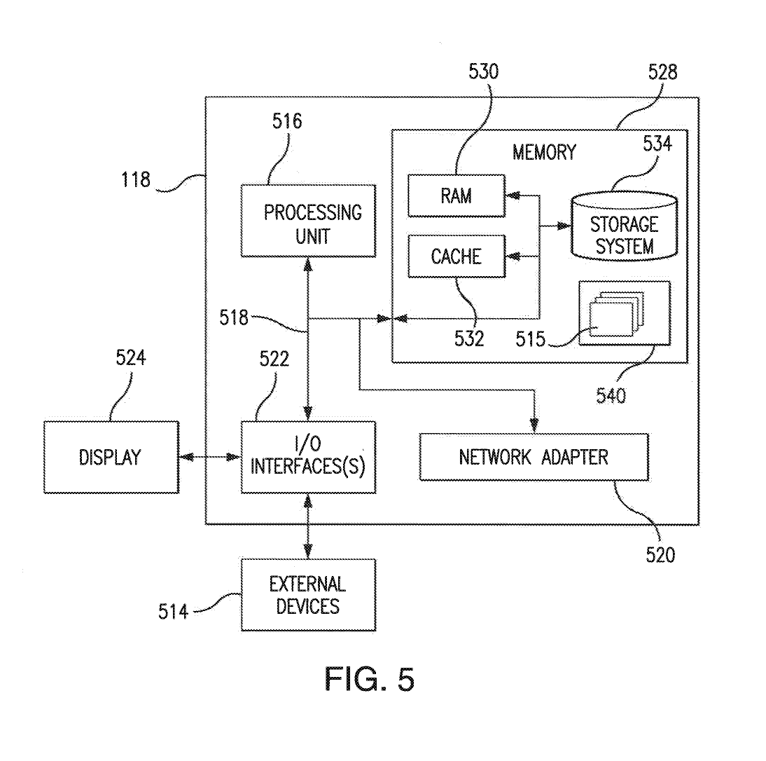

Embodiments of geolocation application 120 may be implemented or executed by one or more computer systems. One such computer system, geolocation server 118 is illustrated in FIG. 5. In various embodiments, geolocation server 118 may be a server, a mainframe computer system, a workstation, a network computer, a desktop computer, a laptop, or the like.

Geolocation server 118 is only one example of a suitable system and is not intended to suggest any limitation as to the scope of use or functionality of embodiments of the invention described herein. Regardless, geolocation server 118 is capable of being implemented and/or performing any of the functionality set forth hereinabove.

Geolocation server 118 is operational with numerous other general purpose or special purpose computing system environments or configurations. Examples of well-known computing systems, environments, and/or configurations that may be suitable for use with geolocation server 118 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed data processing environments that include any of the above systems or devices, and the like.

Geolocation server 118 may be described in the general context of computer system-executable instructions, such as program modules, being executed by a computer system. Generally, program modules may include routines, programs, objects, components, logic, data structures, and so on that perform particular tasks or implement particular abstract data types. Geolocation server 118 may be practiced in distributed data processing environments where tasks are performed by remote processing devices that are linked through a communications network. In a distributed data processing environment, program modules may be located in both local and remote computer system storage media including memory storage devices.

Geolocation server 118 is shown in FIG. 5 in the form of a general-purpose computing device. The components of geolocation server 118 may include, but are not limited to, one or more processors or processing units 516, a system memory 528, and a bus 518 that couples various system components including system memory 528 to processor 516.

Bus 518 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Geolocation server 118 typically includes a variety of computer system readable media. Such media may be any available media that is accessible by geolocation server 118, and it includes both volatile and non-volatile media, removable and non-removable media.

System memory 528 can include computer system readable media in the form of volatile memory, such as random access memory (RAM) 530 and/or cache memory 532. Geolocation server 118 may further include other removable/non-removable, volatile/non-volatile computer system storage media. By way of example only, storage system 534 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 518 by one or more data media interfaces. As will be further depicted and described below, memory 528 may include at least one program product having a set (e.g., at least one) of program modules that are configured to carry out the functions of embodiments of the invention.

Program/utility 540, having a set (at least one) of program modules 515, such as geolocation application 120, may be stored in memory 528 by way of example, and not limitation, as well as an operating system, one or more application programs, other program modules, and program data. Each of the operating system, one or more application programs, other program modules, and program data or some combination thereof, may include an implementation of a networking environment. Program modules 515 generally carry out the functions and/or methodologies of embodiments of the invention as described herein.

Geolocation server 118 may also communicate with one or more external devices 514 such as a keyboard, a pointing device, a display 524, etc.; one or more devices that enable a user to interact with geolocation server 118; and/or any devices (e.g., network card, modem, etc.) that enable geolocation server 118 to communicate with one or more other computing devices. Such communication can occur via Input/Output (I/O) interfaces 522. Still yet, geolocation server 118 can communicate with one or more networks such as a local area network (LAN), a general wide area network (WAN), and/or a public network (e.g., the Internet) via network adapter 520. As depicted, network adapter 520 communicates with the other components of geolocation server 118 via bus 518. It should be understood that although not shown, other hardware and/or software components could be used in conjunction with geolocation server 118. Examples, include, but are not limited to: microcode, device drivers, redundant processing units, external disk drive arrays, RAID systems, tape drives, and data archival storage systems, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for determining mobile device location in a wireless communication network having plural base stations and at least one repeater for communicating with a mobile device, where the wireless communication network uses a geolocation detection program for locating a mobile device, wherein the improvement comprises determining whether a signal received from the mobile device has passed through the at least one repeater.

2. The method of claim 1 wherein determining whether a signal received from the mobile device has passed through the at least one repeater includes determining a communication network propagation time delay between a base station and the mobile device.

3. The method of claim 2 wherein determining whether a signal received from the mobile device has passed through the at least one repeater further includes determining if the communication network propagation time delay is greater than a known propagation time delay associated with the at least one repeater.

4. The method of claim 3 wherein determining whether a signal received from the mobile device has passed through the at least one repeater further includes determining the propagation time delay associated with the at least one repeater and prescribing it as the known propagation time delay associated with the at least one repeater.

5. The method of claim 3 wherein the wireless communication network is configured for use as a LTE, GSM or UMTS mobile communication network.

6. The method of claim 1 wherein the improvement further comprises providing indication that a mobile device as passed through the at least one repeater if it is determined a signal received from the mobile device has passed through the at least one repeater.

7. The method of claim 1 wherein the at least one repeater is a tethered repeater.

8. An apparatus for use in wireless communication system having at least one base station and a repeater station coupled to the at least one base station comprising a computer system having one or more processors and memory storing one or more programs for execution by the one or more processors configured for locating a mobile device in the wireless communications system and determining whether a signal received from a mobile device communicating with the wireless communication system has passed through the at least one repeater.

9. The apparatus of claim 8 wherein the computer system is further configured to determine a communication network propagation time delay between a base station and the mobile device.

10. The apparatus of claim 9 wherein the computer system is further configured to determine if the communication network propagation time delay is greater than a known propagation time delay associated with the at least one repeater.

11. The apparatus of claim 9 wherein the computer system is further configured to determine the propagation time delay associated with the at least one repeater and prescribing it as the known propagation time delay associated with the at least one repeater.

12. The apparatus of claim 8 wherein the wireless communication system is configured for use as a LTE, GSM or UMTS mobile communication network.

13. The apparatus of claim 8 wherein the wherein the computer system is further configured to provide indication that a mobile device as passed through the at least one repeater if it is determined a signal received from the mobile device has passed through the at least one repeater.

14. The apparatus of claim 8 wherein the at least one repeater is a tethered repeater.

15. A non-transitory computer readable storage medium and one or more computer programs embedded therein, the computer programs comprising instructions, which when executed by a computer system, cause the computer system to distinguish repeater locations in a wireless communications network having a plurality of repeaters deployed for a common wireless network cell wherein each repeater is provided with a fixed pattern of a serving cell and neighbor cells wherein a serving cell is characterized by a cell having a strongest signal relative to other cells whereby the serving and neighbor cells communicate with a repeater and wherein mobile devices report their respective Radio Resource Control (RRC)/Direct Transfer Application Part (DTAP) measurement reports regarding a serving cell and neighbor cells whereby the computer system uses a geolocation detection algorithm to determine at which one of the plurality of repeaters a mobile device is located in proximity to contingent upon the reported mobile device measurement reports.

16. The non-transitory computer readable storage medium of claim 15 wherein determining using a geolocation detection scheme to determine a repeater a mobile device is located in proximity to includes differentiating a plurality of repeater locations contingent upon a serving cell and reported neighbor cells.

17. The non-transitory computer readable storage medium of claim 15 wherein mobile devices report their respective RRC/DTAP measurement reports regarding a serving cell and neighbor cells in conjunction with respective power levels.

18. The non-transitory computer readable storage medium of claim 16 wherein using a geolocation detection algorithm includes analyzing power margin levels between neighbor cells to detect a characteristic pattern to determine differentiation between repeaters on a serving cell.

19. The non-transitory computer readable storage medium of claim 18 wherein relative power margin levels are used between neighbor cells to detect characteristic patterns to determine differentiation between repeaters on a serving cell.

20. The non-transitory computer readable storage medium of claim 15 wherein the wireless communication system is configured for use as a LTE, GSM or UMTS mobile communication network.
